(19) United States
(12) Patent Application Publication
(10) Pub. No.: US 2019/0180295 A1
(43) Pub. Date: Jun. 13, 2019

(54) METHOD FOR APPLYING CONJOINT ANALYSIS TO RANK CUSTOMER PRODUCT PREFERENCE

(71) Applicant: Edwin Geoffrey Hartnell, Milpitas, CA (US)

(72) Inventor: Edwin Geoffrey Hartnell, Milpitas, CA (US)

(21) Appl. No.: 16/208,730

(22) Filed: Dec. 4, 2018

Related U.S. Application Data
(60) Provisional application No. 62/598,264, filed on Dec. 13, 2017.

(51) Int. Cl. G06Q 30/02; G06F 17/18

(52) U.S. Cl. CPC G06Q 30/0201; G06F 17/18; G06Q 30/0282

(57) ABSTRACT

This invention eliminates the need for Retailers and Customers to complete traditional customer survey systems and methods, replacing them with a data collection system and method configured to analyze data related to consumer behavioral activities and product preferences. Specifically, the survey system and method gathers and stores Customer data in a quantifiable manner relating to a Customer's purchase preferences, typically by surveying that Customer and applying an algorithm to rank each Customer's Product preference. This survey replacement system uses data from customer behavior tracking log files, also known as, Customer Clickstreams, eCommerce Clickstream, Product Clickstreams or Click Path Data, and subjects this data to Conjoint Analysis using multiple linear regression analysis, among other analysis, to rank Product Preferences using the Product Attributes.

### CROSS-REFERENCE TO RELATED APPLICATIONS

This application claims the benefit of the following provisional application, which is hereby incorporated by reference in its entirety: 62/598,264 filed Dec. 13, 2017, the entire disclosure of which is incorporated herein by reference.

### FIELD OF THE INVENTION

The present invention generally relates to a method to efficiently permit Retailers and Customers to rank their product preferences based upon a Recency-Frequency-Duration-Engagement-Monetary method, among other methods, using Customer Behavior data collected by a website using eCommerce Clickstream as the input. In an exemplary embodiment, the invention has three (3) input ports and three (3) output ports, each of which and all of which, may be configured to provide the customer's preferences for any particular attribute or combination of attributes of a particular product. A web-based graphical user interface or a desktop application running on Windows or Linux is employed to present the method to a user (e.g., via a user device such as a computing device, smartphone, tablet, or any other suitable device).

### BACKGROUND OF THE INVENTION

Conjoint analysis is a survey-based statistical technique employed in market research that assists its users in determining how Customers value different attributes of a product, such as price, feature, delivery, or some combination therewith, resulting in a systematic analysis of Customer decisions and their related preferences. In the past, Conjoint Analysis depended upon physical or online surveys that tested subjects manually through a set of trade off decisions for a given set of Product Attributes. Existing analysis methods have a number of limitations including, but not limited to, small sample sizes, results that lag real-time conditions, and complex and expensive data collection protocols.

Therefore, there is a need in the art to reduce or eliminate the drawbacks associated with manual Conjoint Analysis methods by implementing an eCommerce Clickstream. These and other features and advantages of the present invention will be explained and will become obvious to one skilled in the art through the summary of the invention that follows.

### SUMMARY OF INVENTION

According to the embodiment of the present invention, a system and method are provided to consumers using a web-based graphical user interface to quickly and efficiently analyze and rank their product preference on a website. A Customer interfaces with the merchant's website, such interfacing establishing a Behavior Tracking Log File (LOG FILE) that is unique to that Customer. Because such LOG FILE tracks the customer's activity, they may provide the source data for the present invention embodiment. The present invention applies Conjoint Analysis through such tools as multiple linear regression analysis to rank product preferences for a product attribute deemed important by a merchant. This ranking of product attributes enhances the merchant's marketing strategy by evidencing customer preferences. The final step is to calculate the importance of each product attribute to each Customer using a Part-Worth Utility Level value within each Attribute.

The foregoing summary of the present invention with its exemplary embodiments should not be construed to limit the scope of the invention. It will be apparent to one skilled in the art that, based on the embodiments as described herein, features of the invention may be further combined or modified without departing from its scope.

### BRIEF DESCRIPTION OF THE DRAWINGS

FIG. 1 is a Clickstream Conjoint Architecture for a Clickstream Conjoint Node, in accordance with at least some exemplary embodiments of the present disclosure;

FIG. 2 is an illustration of the data flow from the Input/Upstream Nodes, through the Clickstream Conjoint Node, and to the Output/Downstream Nodes, in accordance with at least some exemplary embodiments of the present disclosure;

FIG. 3 is an illustrative example of a user interface for the Clickstream Conjoint Node, in accordance with at least some exemplary embodiments of the present disclosure;

FIG. 4 is a table explaining the various nodes of the Clickstream, in accordance with at least some exemplary embodiments of the present disclosure;

FIG. 5 in an exemplary graph of an output generated by the Clickstream Conjoint Node, in accordance with at least some exemplary embodiments of the present disclosure;

FIG. 6 is a schematic illustration of an exemplary computing device, in accordance with at least some exemplary embodiments of the present disclosure; and

FIG. 7 is a schematic illustration of an exemplary network, in accordance with at least some exemplary embodiments of the present disclosure.

### DETAILED SPECIFICATION

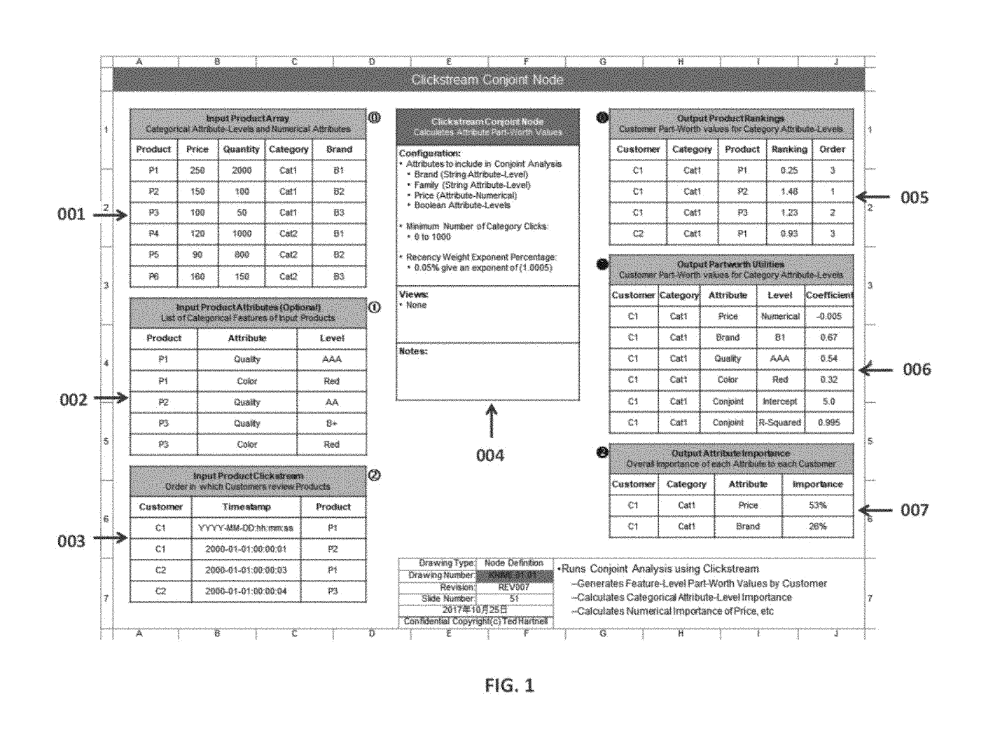

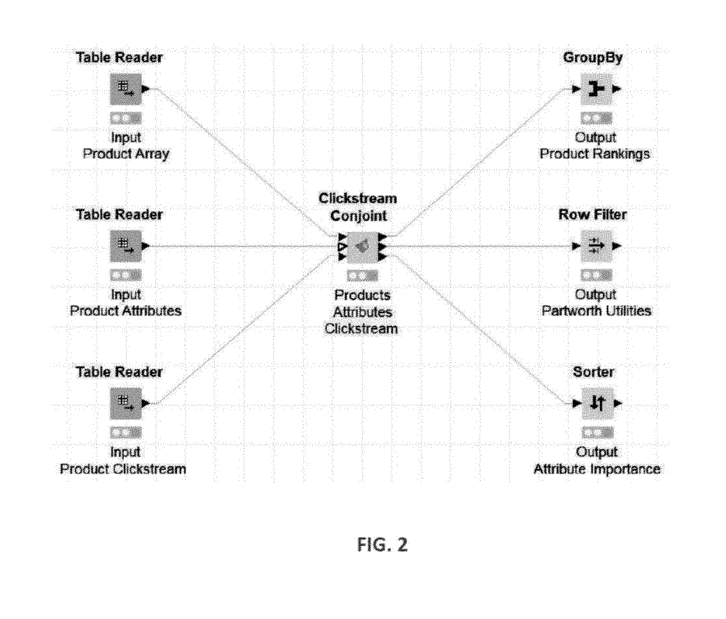

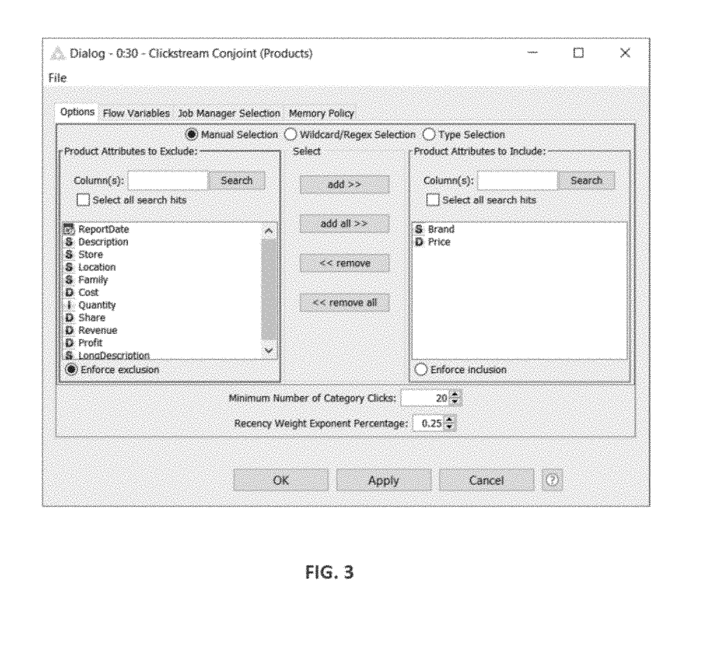

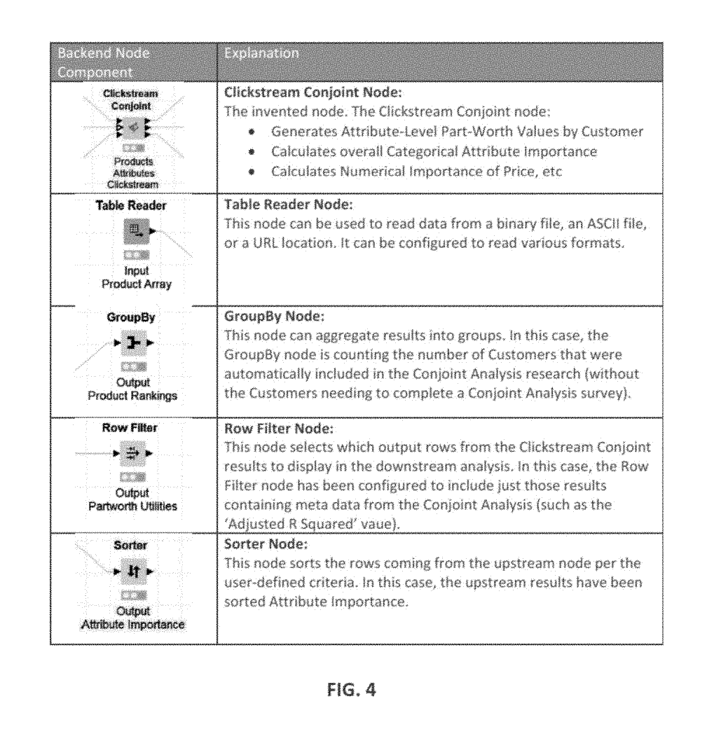

Embodiments of the present invention are generally directed towards systems and methods of surveying customers for their behavioral activities and product preferences, as illustrated in FIGS. 1-5. For example, these embodiments may gather and store Customer data in a quantifiable manner relating to a Customer's purchase preferences, typically by surveying that Customer and applying an algorithm to rank each Customer's Product preference. This method increases the Customer's relative preference for a given Product based on the more recently viewed the Product (e.g., based on how recently the Product has been viewed), the frequency of a view, the duration of such view, the Customer's engagement with the Product and the monetary value the Customer placed on the Product. The present embodiment uses data from customer behavior tracking log files, also known as, Customer Clickstreams, eCommerce Clickstream, Product Clickstreams or Click Path Data, subjecting this data to Conjoint Analysis using multiple linear regression analysis, among other analysis, to rank Product Preferences using the Product Attributes. An exemplary embodiment may be a web-based interface that may be configured to capture and store the data from the LOG FILES in three (3) input ports as shown in FIG. 1. These input ports are (1) Input Product Array (001); (2) Input Product Attributes (002) and (3) Input Product Clickstream (003).

The Input Product Array (001) table contains data about the set of Products included in the market research. These products are made up of the Attributes (e.g., the features, functions and benefits) considered by the Customer when shopping or making a purchase decision. The Product column and the Category column may constitute the columns in the Input Product Array. Other columns containing Categorical Attributes (string or boolean values) such as Brand, Store Location, Family, Category and Platform or containing Numerical Attribute (floating-point or integer values) such as Price, Size and Quantity can be selected by the user to be included in the Conjoint Analysis study. The Clickstream Conjoint Node (004) will then calculate the Customer Importance of each of these attributes.

In the Input Product Array table, the Product's name may be the unique name of each Product. The “No Sale” Product may not be included as it may be found in the Input Product Clickstream table. Category may be the category of the Product. The Clickstream Conjoint Node (004) automatically groups Product Attributes into Categories and ranks the importance of each Product Attribute by Category. Brand is typically a factor (e.g., an important factor) in a Customer's decision to purchase the Product. Categorical Attributes may be small in number, (up to 4), and there should be few missing values. Price is the price of each Product and may be included in Conjoint Analysis. If Price is included in the Input Product Array table, then it may be treated as a Numerical Attribute. However, if Price is included in the Input Product Attributes table, then it may be treated as a Categorical Attribute. The same may be true of any floating point or integer value included in the Input Product Attributes table because, in an exemplary embodiment, the Input Product Attributes table may handle String values. In other embodiments, the Input Product Attributes table may be configured to handle other values (e.g., other than String values). The exemplary Conjoint Analysis may treat Prices as a Categorical Attribute and may test between two (2) and six (6) Price Levels.

The Input Product Attribute (002) may list the set of Categorical Attributes that are found within each Product and these can be in addition to or different from the Categorical Attributes found within the Input Product Array (001). If the same Attribute Level is found in both places then the value found in this table will override the value found in the Input Product Array table. The Input Product Attribute's Categorical Attributes may also be included in the Conjoint Analysis study as well. This table may offer an efficient technique (e.g., may offer a convenience to users) when many Categories are being analyzed by the Clickstream Conjoint Node. As different Product Categories may have different feature sets, including all of the Categorical Attributes in the Input Product Array may result in a very wide table with many columns and many Missing Values.

In an exemplary embodiment, the Input Product Attributes columns may include: Product, the unique name of each Product; Attribute, a high-level set of characteristics of the Products within the Category such as Brand, Color, Flavor and Form (e.g., which may be examples of Attributes), but may include additional, fewer, or alternate columns in other embodiments. In this table, Level may refer to the detailed characteristic present in the given Product such as Color (e.g., Blue).

The Input Product Clickstream (003) table contains Customer Behavior data. It lists the set of customers who visited the website alongside the set of Products viewed by those Customers (e.g., listed in order of visit) including which Products the Customer viewed and how the Customer's engaged with those Products. The Clickstream Conjoint Node may calculate the importance of the Product to the Customer using this Customer Behavior data.

The Input Product Clickstream (003) may note web-crawlers and other Customers (e.g., suspicious Customers) who may view relatively high numbers of Product pages in an unusual order and may filter such activity out upstream of this node. The table may contain a Product Category as the unique name or other identifier for each Product, and this unique name or identifier may match the Products found in the Input Product Array (001) and Input Product Attributes (002) tables. The Input Product Clickstream (003) may also have a date-time field that can be used to help determine the duration in which a Customer stayed on the Product page.

In an exemplary embodiment, the Clickstream Conjoint Node (004) may receive data from a plurality of ports (e.g., the above-described ports), and it may be configured to include the data in the Conjoint Analysis (e.g., the Brand, Family, and other String, Boolean, or Numeric Attribute-Levels such as Price). Then, the Clickstream Conjoint Node (004) may send its output to three (3) output ports that may be the (1) Output Product Rankings, (005); (2) Output Part-Worth Utilities (006) and (3) Output Attribute Importance (007) as shown in FIG. 1.

Turning now to the output ports, the Output Product Rankings Table (005) lists the calculated results from the first step of Conjoint Analysis. This estimated preference for each Product is ranked by Customer according to a Recency-Frequency-Duration-Engagement-Monetary algorithm that is applied to the Clickstream Log File. In an exemplary embodiment, the Output ranking may contain columns such as Customer, Category, Product, Ranking and Order, and may also include additional, fewer, or alternate columns in other embodiments. Customer may be a unique identifier for each customer found in the Input Product Clickstream shopping for Products within the Category. Category may be the name of the Category of Products that the customer may be shopping within. Product may be the name of each Product that the Customer clicked on during their shopping journey within the Category. Ranking may be a double value indicating the degree of preference a Customer placed upon the Product. For example, a high Ranking indicate a high degree of preference. Order may be an integer count that also indicates the degree of preference the Customer placed upon the Product.

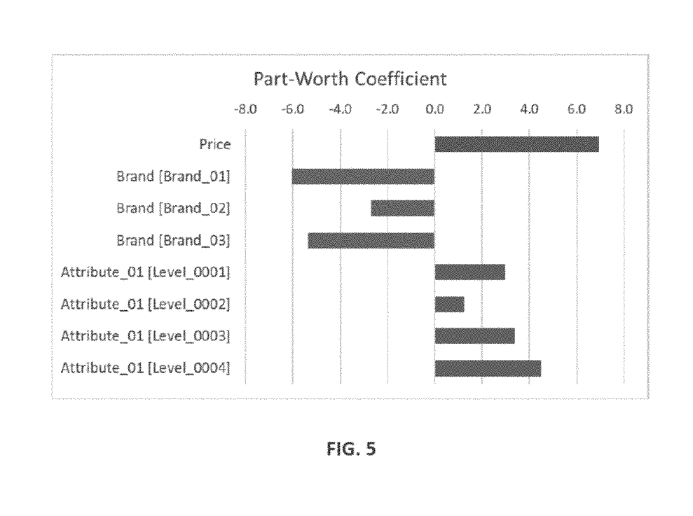

The Output Part-Worth Utilities (006) table may contain the calculated results from the second step of Conjoint Analysis when a multiple regression analysis compares each Customer's Total Utility against the presence or absence of the Categorical Attributes of the Products, as well as the Numerical Attributes of the Products. The beta coefficients may be calculated for each Attribute-Level according to a Least Squares Multiple Linear Regression algorithm. In an exemplary embodiment, the columns may be Customer, Category, Attribute, Level and Coefficient, and may also include additional, fewer, or alternate columns in other embodiments. Customer and Category may be similar to those appearing in the Output Product Rankings. Level in the Output Part-Worth Utilities may refer to a sub-set of Attribute-Levels selected using a fractional factorial design. Coefficient may refer to the Part-Worth Utility value for each Attribute level. These values may be expressed in units of utility (e.g., “utils.”). Exemplary Part-Worth coefficients are illustrated in FIG. 5.

The Output Attribute Importance (007) table may contain the results from the final step of Conjoint Analysis when Part-Worth Utilities from individual Customers are aggregated into overall Importance Levels. In an exemplary embodiment, the Output Attributes Importance table may contain these columns: Customer, Category, Attributes, Maximum, Minimum, Range, Importance and Order, and may also include additional, fewer, or alternate columns in other embodiments. Maximum may refer to the maximum raw Part-Worth Utility Coefficient across all Levels within the Category Attribute. Minimum may refer to the minimum raw Part-Worth Utility Coefficient across all levels within the Category Attribute. Ranges may refer to the difference between the maximum Part-Worth Utility Coefficient and the minimum Part-Worth Utility Coefficient across all Levels within the Attribute. Importance may refer to the “Percentage Relative Importance” of each Attribute to each Customer according to the formula described above. Order may refer to an integer count that also indicates the degree of Importance the Customer placed upon the Attribute.

In at least some exemplary embodiments, the exemplary disclosed system and method may provide Conjoint Analysis research without designing a customer survey or obtaining answers to survey questions from respondents. The exemplary disclosed system and method may use actual customer shopping activity data. The exemplary disclosed system and method may apply customer behavior tracking log files to identify an optimal sub-set of product attributes that expose useful information from an experiment running a full factorial design. The exemplary disclosed system and method may automatically mix and compare continuous numerical attributes with categorical attributes when conducting Conjoint Analysis research. The exemplary disclosed system and method may dynamically update a statistical inference about the unmet needs of one or more online customers and respond to those needs in real time. The exemplary disclosed system and method may optimally reduce the amount of unsuitable information provided to an online customer based upon a statistical inference about the customer's consumer objectives. The exemplary disclosed system and method may automatically design and price an optimal product or service for a customer in real time based upon a statistical inference about the customer's consumer objectives.

In at least some exemplary embodiments, the exemplary disclosed system may include a preference ranking module, comprising computer-executable code stored in non-volatile memory, a processor, and a user device. The preference ranking module, the processor, and the user device may be configured to capture and store data of customer behavior of one or more customers, the data including a plurality of product attributes of one or more products, perform a conjoint analysis on the data, and rank a plurality of product preferences based on performing the conjoint analysis on the data including the plurality of product attributes. Ranking the plurality of product preferences may include grouping the plurality of product attributes into categories and ranking a customer importance of each product attribute by category. Ranking the plurality of product preferences may include ranking the plurality of product preferences by customer. The data of customer behavior of one or more customers may include one or more customer behavior tracking log files. The data of customer behavior of one or more customers may be selected from the group consisting of a customer clickstreams, an eCommerce clickstream, a product clickstreams, and click path data. Performing the conjoint analysis on the data may include using multiple linear regression analysis. Ranking the plurality of product preferences by customer may include ranking according to a Recency-Frequency-Duration-Engagement-Monetary algorithm that is applied to the data of customer behavior of one or more customers that is one or more clickstream log files. The data of customer behavior of one or more customers may include data selected from the group consisting of a unique identifier for each of the one or more customers, a product name and a product category name. The data of customer behavior of one or more customers may include a ranking value that indicates a degree of preference that a customer places upon a product. The data of customer behavior of one or more customers may include an integer count that indicates a degree of preference that a customer places upon a product. Ranking the plurality of product preferences may include comparing a customer total utility of each of a plurality of customers against a presence or an absence of a plurality of categorical attributes of the one or more products. Comparing the customer total utility may include calculating beta coefficients for each of a plurality of attribute-levels according to a Least Squares Multiple Linear Regression algorithm. Ranking the plurality of product preferences may include aggregating a customer total utility of each of a plurality of customers into an overall customer importance level.

The present invention will utilize at least one or more of the following machine learning approaches, among others: tree-based model, neural networks, traditional regression, clustering, association and sequence rules and Bayesian approaches. An exemplary embodiment of the system may combine the modelling approaches to minimize errors/residuals.

In some embodiments, present invention may be configured to utilize Bayesian inference as method of statistical inference in which Bayes' theorem is used to update the probability for a hypothesis as more evidence or information becomes available through eClickstream thereby enhancing the confidence range results.

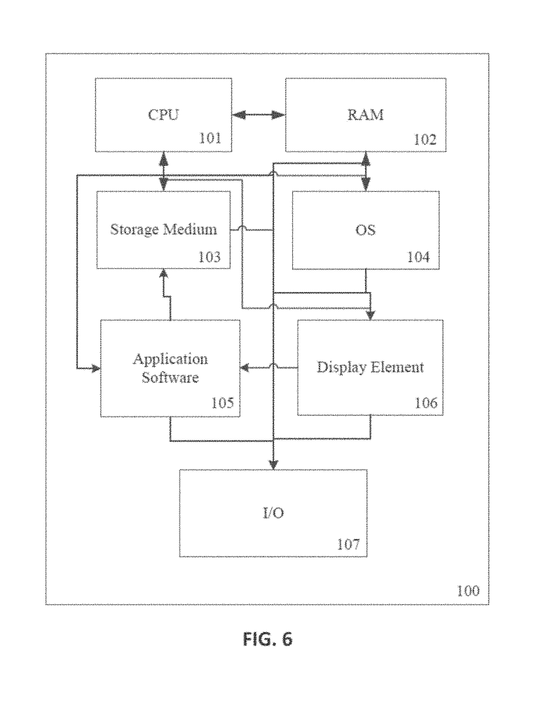

To perform the above steps, the system and method are accomplished using one or more computing devices. As shown in FIG. 6, one of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, a display element 106 and one or more input/output devices/means 107. Examples of computing devices usable with embodiments of the present invention include, but are not limited to, proprietary computing devices, personal computers, mobile computing devices, tablet PCs, mini-PCs, servers or any combination thereof. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

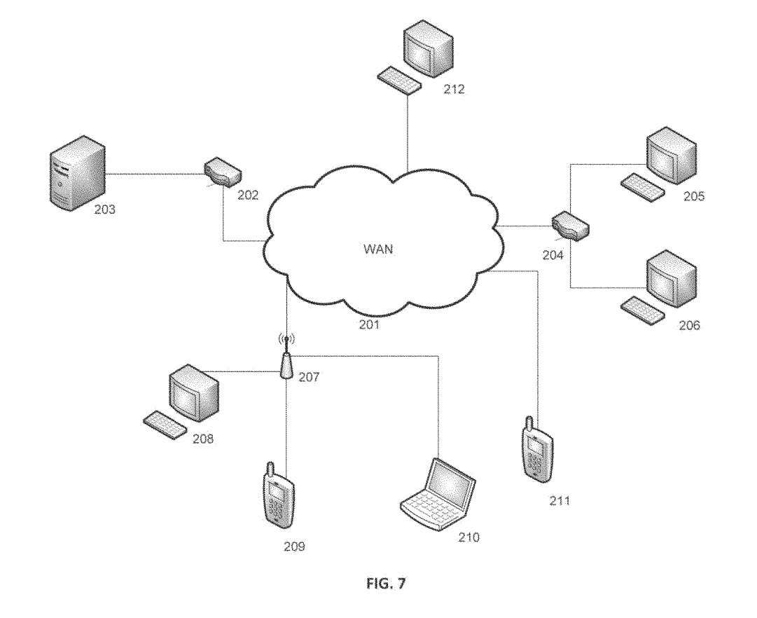

Referring to FIG. 7, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 7, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present invention, and embodiments of the present invention are contemplated for use with any communications means.

Traditionally, a computer program consists of a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. There may be aspects of this invention that may be practiced without the implementation of some features as they are described. It should be understood that some details have not been described in detail in order to not unnecessarily obscure the focus of the invention. The invention is capable of myriad modifications in various obvious aspects, all without departing from the spirit and scope of the present invention. Accordingly, the drawings and descriptions are to be regarded as illustrative rather than restrictive in nature.

What is claimed is:

1. A preference ranking system, comprising:
a preference ranking module, comprising computer-executable code stored in non-volatile memory;
a processor; and
a user device;
wherein the preference ranking module, the processor, and the user device are configured to:
capture and store data of customer behavior of one or more customers, the data including a plurality of product attributes of one or more products;
perform a conjoint analysis on the data; and
rank a plurality of product preferences based on performing the conjoint analysis on the data including the plurality of product attributes;
wherein ranking the plurality of product preferences includes grouping the plurality of product attributes into categories and ranking a customer importance of each product attribute by category; and
wherein ranking the plurality of product preferences includes ranking the plurality of product preferences by customer.

2. The preference ranking system of claim 1, wherein the data of customer behavior of one or more customers includes one or more customer behavior tracking log files.

3. The preference ranking system of claim 1, wherein the data of customer behavior of one or more customers is selected from the group consisting of a customer clickstream, an eCommerce clickstream, a product clickstream, and click path data.

4. The preference ranking system of claim 1, wherein performing the conjoint analysis on the data includes using multiple linear regression analysis.

5. The preference ranking system of claim 1, wherein ranking the plurality of product preferences by customer includes ranking according to a Recency-Frequency-Duration-Engagement-Monetary algorithm that is applied to the data of customer behavior of one or more customers that is one or more clickstream log files.

6. The preference ranking system of claim 1, wherein the data of customer behavior of one or more customers includes data selected from the group consisting of a unique identifier for each of the one or more customers, a product name, and a product category name.

7. The preference ranking system of claim 1, wherein the data of customer behavior of one or more customers includes a ranking value that indicates a degree of preference that a customer places upon a product.

8. The preference ranking system of claim 1, wherein the data of customer behavior of one or more customers includes an integer count that indicates a degree of preference that a customer places upon a product.

9. The preference ranking system of claim 1, wherein ranking the plurality of product preferences includes comparing a customer total utility of each of a plurality of customers against a presence or an absence of a plurality of categorical attributes of the one or more products.

10. The preference ranking system of claim 9, wherein comparing the customer total utility includes calculating beta coefficients for each of a plurality of attribute-levels according to a Least Squares Multiple Linear Regression algorithm.

11. The preference ranking system of claim 1, wherein ranking the plurality of product preferences includes aggregating a customer total utility of each of a plurality of customers into an overall customer importance level.

12. A method, comprising:
capturing and storing data of customer behavior of one or more customers, the data including a plurality of product attributes of one or more products;
performing a conjoint analysis on the data; and
ranking a plurality of product preferences based on performing the conjoint analysis on the data including the plurality of product attributes;
wherein ranking the plurality of product preferences includes grouping the plurality of product attributes into categories and ranking a customer importance of each product attribute by category; and
wherein ranking the plurality of product preferences includes ranking the plurality of product preferences by customer.

13. The method of claim 12, wherein the data of customer behavior of one or more customers includes one or more customer behavior tracking log files.

14. The method of claim 12, wherein the data of customer behavior of one or more customers is selected from the group consisting of a customer clickstream, an eCommerce clickstream, a product clickstream, and click path data.

15. The method of claim 12, wherein performing the conjoint analysis on the data includes using multiple linear regression analysis.

16. The method of claim 12, wherein ranking the plurality of product preferences by customer includes ranking according to a Recency-Frequency-Duration-Engagement-Monetary algorithm that is applied to the data of customer behavior of one or more customers that is one or more clickstream log files.

17. The method of claim 12, wherein the data of customer behavior of one or more customers includes data selected from the group consisting of a unique identifier for each of the one or more customers, a product name, and a product category name.

18. A preference ranking system, comprising:
a preference ranking module, comprising computer-executable code stored in non-volatile memory;
a processor; and
a user device;
wherein the preference ranking module, the processor, and the user device are configured to:
capture and store data of customer behavior of one or more customers, the data including a plurality of product attributes of one or more products;
perform a conjoint analysis on the data; and
rank a plurality of product preferences based on performing the conjoint analysis on the data including the plurality of product attributes;
wherein ranking the plurality of product preferences includes grouping the plurality of product attributes into categories and ranking a customer importance of each product attribute by category;
wherein ranking the plurality of product preferences includes ranking the plurality of product preferences by customer; and
wherein ranking the plurality of product preferences includes comparing a customer total utility of each of a plurality of customers against a presence or an absence of a plurality of categorical attributes of the one or more products.

19. The preference ranking system of claim 18, wherein comparing the customer total utility includes calculating beta coefficients for each of a plurality of attribute-levels according to a Least Squares Multiple Linear Regression algorithm.

20. The preference ranking system of claim 18, wherein ranking the plurality of product preferences includes aggregating a customer total utility of each of the plurality of customers into an overall customer importance level.
